(19) United States
(12) Patent Application Publication
(10) Pub. No.: US 2003/0236758 A1
(43) Pub. Date: Dec. 25, 2003

(54) Storage service method and storage service program

(75) Inventors: Sawao Iwatani, Kawasaki (JP); Shigeru Honmura, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/341,042

(22) Filed: Jan. 13, 2003

(30) Foreign Application Priority Data
Jun. 19, 2002 (JP) 2002-178479

(51) Int. Cl. G06F 17/60

(52) U.S. Cl. 705/400; 705/418

(57) ABSTRACT

The present invention provides a storage service method to be adopted in a storage apparatus managing storage devices, that a server accesses to store information, a storage service program thereof and a storage apparatus thereof. First, access volume information indicating the volume of accesses to a storage apparatus of the server is obtained, and then, a storage service fee to be charged to the server is calculated based on the obtained access volume information. Thus, a rental fee can be charged in accordance with actually used storage capacity.

### BACKGROUND OF THE INVENTION

1. Field of the Invention

The present invention relates to a network storage service, such as a connection service, information storage service and the like with which a service provider provides users through a network, and in particular, it relates to a network storage service system providing the service in accordance with the amount of use of each user.

2. Description of the Related Art

Recently, business for a storage service provider (SSP) renting storage devices (memory areas secured on a hard disk and the like) to clients and charging rental fees (storage service) has grown. Specifically, in this system, a storage service provider prepares a storage apparatus in a client-server (requester's processing device). A client requests the storage service provider to secure necessary storage capacity and pays a rental fee for the capacity.

Charging a rental fee for the use of computer resources, including a storage device is conventionally performed by not only a storage apparatus service provider but also other operators.

However, the conventional storage service provision and charging have the following problems.

Problem 1: Since storage service/general charging is based on a contracted capacity and is not based on the actual amount used, a user that does not use much storage device must pay a rental fee for more than what he/she has actually used. If there is a user with a small amount of storage device, a storage service provider can suppress costs by sharing his/her storage device with other users, since the load of the user with a low use rate is small. Therefore, it is desirable for a storage service provider to charge less to a user that uses less than the contracted capacity. However, such a storage service method is not established.

Problem 2: If a storage service provider cannot provide a client with a specific storage function, it is natural to compensate for such poor service by reducing the rental fee. Nevertheless, even in such a case, currently the provider charges the same rental fee by the same charging method since storage service/general charging is based on a contracted capacity.

### SUMMARY OF THE INVENTION

The present invention is made in the situation described above, and it is an object of the present invention to provide a storage service method for charging a rental fee in accordance with an actually used storage capacity, a storage service program thereof and a storage apparatus thereof.

The storage apparatus of the present invention is used to manage storage devices storing information. The storage apparatus comprises an access volume information obtaining unit and a storage service fee calculating unit.

In the first aspect of the present invention, the access volume information obtaining unit obtains access volume information indicating the volume of accesses to a storage apparatus of a requester's processing device.

Then, the storage service fee calculating unit calculates a storage service fee to be charged to the requester's processing device, based on the access volume information obtained by the access volume information obtaining unit.

### BRIEF DESCRIPTION OF THE DRAWINGS

FIG. 1 shows the functional configuration of the first preferred embodiment of the storage apparatus of the present invention;

FIG. 2 is a flowchart showing the process of the first preferred embodiment of the storage apparatus of the present invention;

FIG. 3 shows an example of charging rate fluctuations over a whole day;

FIG. 4 shows an example of charging rate fluctuations varying depending on the number of instances of writing;

FIG. 5 shows the functional configuration of the first preferred embodiment of the storage apparatus of the present invention;

FIG. 6 is a flowchart showing the process of the second preferred embodiment of the storage service of the present invention;

FIG. 7 shows the configuration of the storage apparatus of the present invention; and

FIG. 8 shows the loading onto a computer of the storage service program of the present invention.

### DESCRIPTION OF THE PREFERRED EMBODIMENTS

The present invention adopts the following configuration in order to solve the problems described above.

Specifically, according to one aspect of the present invention, the storage service method, storage service program and storage apparatus of the present invention are realized in a storage apparatus managing storage devices that a requester's processing device accesses to store information. First, access volume information indicating the volume of accesses to a storage apparatus of a requester's processing device is obtained. Then, a storage service fee to be charged to the requester's processing device is calculated based on the obtained access volume information.

In the storage service method, storage service program and storage apparatus of the present invention, it is preferable for the access volume to be the number of access to a storage apparatus.

In the storage service method, storage service program and storage apparatus of the present invention, it is preferable for the storage service fee to vary depending on when the storage device is accessed and to be calculated using a time coefficient that is relatively larger in the daytime than at night.

In the storage service method, storage service program and storage apparatus of the present invention, it is preferable for a writing ratio, which is a ratio of the number of instances of writing to the number of accesses, to be obtained and for a storage service fee to be calculated using a writing coefficient corresponding to the writing ratio.

In the storage service method, storage service program and storage apparatus of the present invention, it is preferable for the access volume to be a process running time during which a storage apparatus is accessed.

In the storage service method, storage service program and storage apparatus of the present invention, it is preferable for the access volume to be an average IO time obtained by dividing the process running time by the number of reads/writes.

The preferred embodiments of the present invention are described below with reference to the drawings.

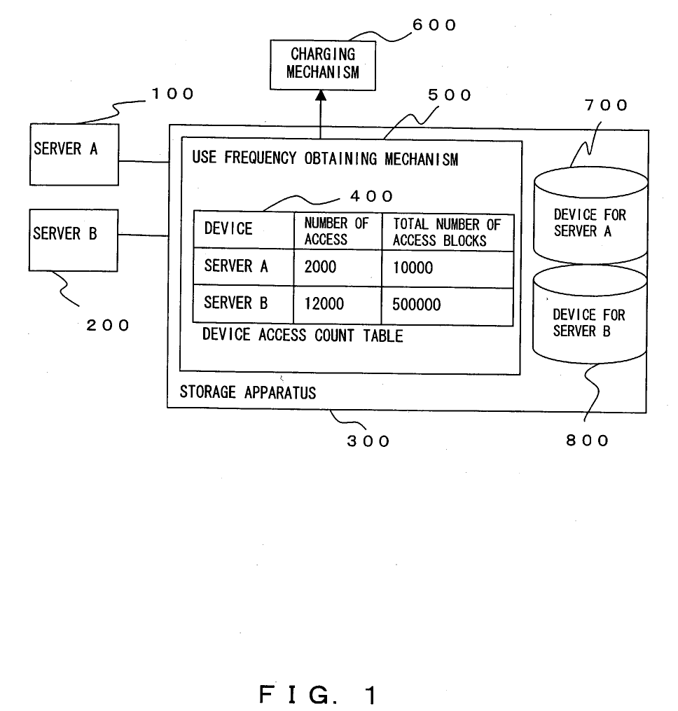

FIG. 1 shows the functional configuration of the first preferred embodiment of the storage apparatus of the present invention.

In FIG. 1, it is preferable for servers A100 and B200, which are requester's processing devices, to be connected to a terminal device that a client uses, which is not shown in FIG. 1. It is preferable for each of the server A100 and B200 to access a storage apparatus 300 through a network, such as the Internet and the like.

Alternatively, each of the server A100 and B200 can be connected to the storage apparatus 300 by a personal computer and the like through the Internet.

The storage apparatus 300 manages a device 700 for server A and a device 800 for server B, being storage devices storing information. The storage apparatus 300 comprises a use frequency obtaining mechanism 500 and a charging mechanism 600. The device 700 for server A is used by the server A100. The server A100 can access the device 700 and read/write information from/onto the device 700. Similarly, the device 800 for server B is used by the server B200. The server B200 can access the device 800 and can read/write information from/onto the device 800. The charging mechanism 600 can be installed in the storage apparatus 300 like the use frequency obtaining mechanism 500 or can be installed separate from the storage apparatus 300.

The use frequency obtaining mechanism 500 obtains access volume information indicating the volume of accesses to the device 700 for server A of the server A100 and also obtains access volume information indicating the degree of access to the device 800 for server B of the server B200. Then, the mechanism 500 writes both of them in a device access count table 400. In this case, the volume is, for example, the access frequency of a storage apparatus.

Specifically, if each of the server A100 and B200 accesses the storage apparatus 300, the use frequency obtaining mechanism 500 judges which is accessed, the device 700 for server A or device 800 for server B and the judgment is reflected in the target device access counting unit of the device access count table 400. For example, if the server A100 accesses the device 700 for server A, the access count of the device 700 for server A of the device access count table 400 is incremented and the number of access blocks due to the access is added to the total number of access blocks.

Then, the charging mechanism 600 calculates a storage service fee to be charged to the server A100 or B200, based on the obtained access volume information. For example, the charging mechanism 600 inquires the use frequency obtaining mechanism 500 about the number of accesses at each specific poling interval (for example, every hour) and calculates both the number of accesses and the differences in the total number of access blocks between poling time intervals per unit time. The differences secured by this charging mechanism 600 are totaled for each billing period (for example, one month), and the number of accesses and the total number of access blocks are calculated.

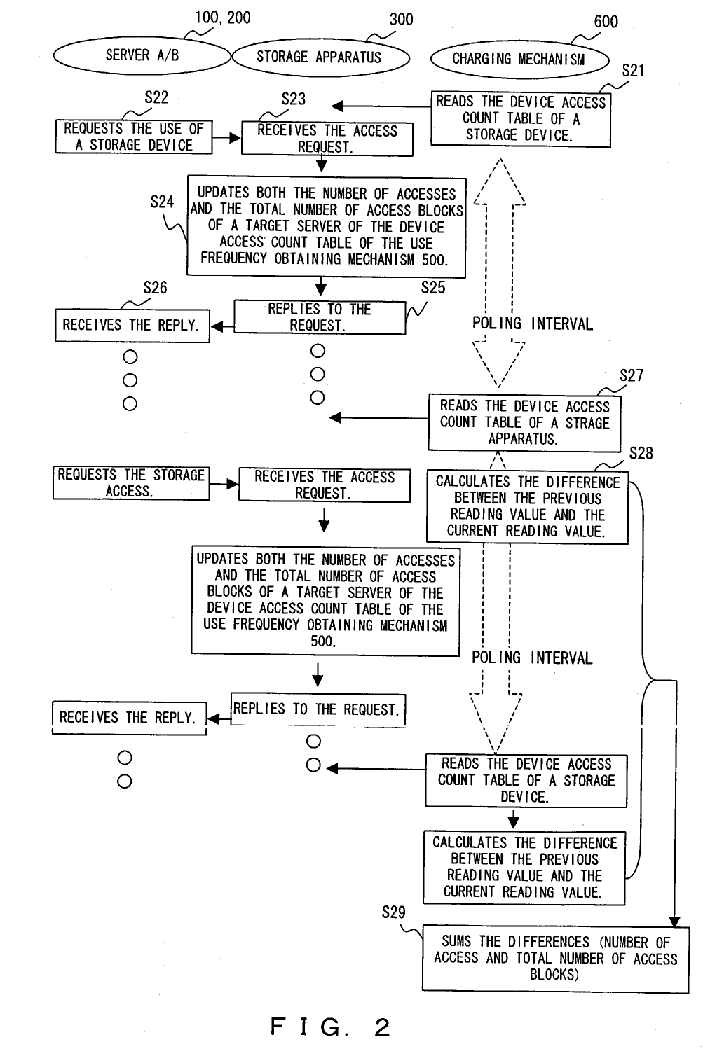

FIG. 2 is a flowchart showing the process of the first preferred embodiment of the storage apparatus of the present invention.

First, in step S21, the charging mechanism 600 reads the device access count table 400 in advance.

Then, in step S22, the server A100 or B200 requests the use of a storage apparatus (device 700 for server A100 or device 800 for server B200) (access to a storage apparatus).

Then, in step S23, the storage apparatus 300 receives the access request. In step S24, it updates the number of accesses and the total number of access blocks of the target server A100 or B200 of the device access table 400, and simultaneously, in step S25, it replies to the access request of the accessed server A100 or B200.

Then, in step S26, the server A100 or B200 receives the reply.

After poling for a specific time after the reading in step S21, in step S27, the charging mechanism 600 reads the device access count table 400 again, and in step S28, it calculates the difference between the current reading value and the previous reading value. These processes (reading and the calculation of the difference) are performed at the end of each poling interval.

Then, in step S29, the differences (the number of accesses and the total number of access blocks) are summed and use frequency is calculated.

Then, a rental fee to be charged to the user of the server A100 or B200 is calculated as follows, using the number of access and the total number of accesses blocks that are calculated above.

Rental fee=Initial fee+Number of accesses×(Fee for each number of access)+Number of access blocks×(Fee for each number of access blocks) (1)

If the provider calculates a parameter based on a system load (hereinafter called a “charging rate”), which is described later, a finer calculation method can be established by using the parameter. In that case, the rental fee is calculated as follows.

$$Rental fee = Initial fee + ( Number of access \times ( Fee for each number of access ) + Number of access blocks \times ( Fee for each number of access blocks ) ) \times Charging rate \qquad ( 2 )$$

For the parameter based on the system load described above, a coefficient that varies depending on time can be used. For example, the storage service fee can be calculated using a time coefficient that is relatively larger in the daytime than at night. For another parameter, a writing coefficient corresponding to a writing ratio, which is the ratio of the number of instances of writing to the number of accesses, can be used.

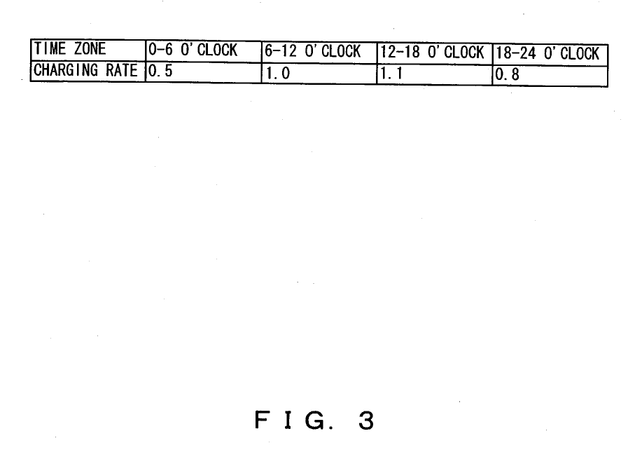

FIG. 3 shows an example of charging rate fluctuations during one day.

As shown in FIG. 3, the charging rate is relatively higher in the daytime since the total use rate is high in the daytime, while it is relatively lower at night since the total use rate is low at night.

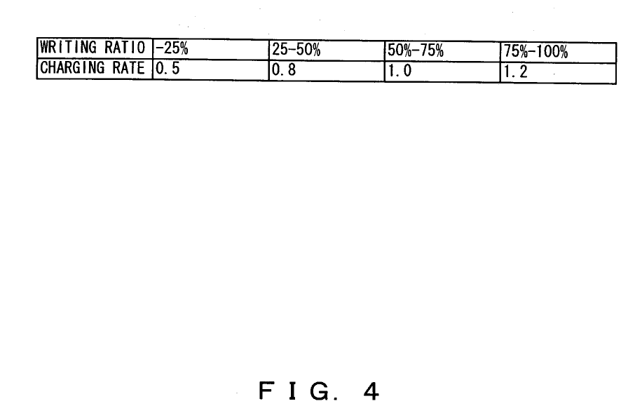

FIG. 4 shows an example of charging rate fluctuations by the number of instances of writing.

As shown in FIG. 4, if the number of instances of writing is small, the charging rate is relatively low since a storage apparatus load is small, while if the number of instances of writing is large, it is relatively high since a storage apparatus load is large. In this case, the use frequency obtaining mechanism 500 can separately count the number of instances of writing and the number of instances of reading, and the writing ratio is calculated based on the number of instances of writing/the number of instances of reading.

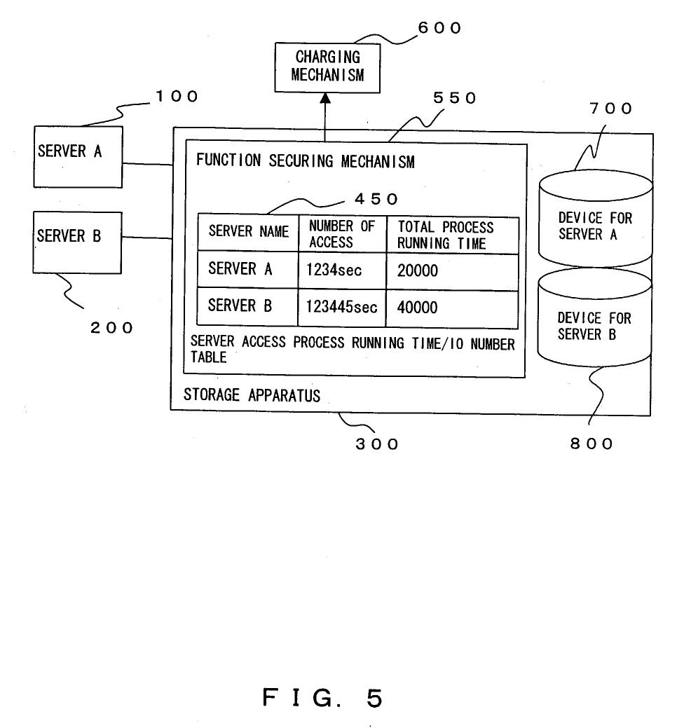

FIG. 5 shows the functional configuration of the first preferred embodiment of the storage apparatus of the present invention.

In FIG. 5, it is preferable for each of the servers A100 and B200 to be connected to the terminal device of a client, which is not shown in FIG. 5, and the server A100 or B200 can access the storage apparatus 300 through a network, such as the Internet and the like.

The storage apparatus 300 manages the device 700 for server A and device 800 for server B which are storage devices storing information. The device 300 comprises a function securing mechanism 550 and a charging mechanism 600. The device 700 for server A is used by the server A100. The server A100 can access the device 700 and read/write information from/onto the device 700. Similarly, the device 800 for server B is used by the server B200. The server B200 can access the device 800 and read/write information from/onto the device 800. The charging mechanism 600 can be installed in the storage apparatus 300 like the use frequency obtaining mechanism 500 or can be installed separately from the storage apparatus 300.

The function obtaining mechanism 550 obtains access volume information indicating the volume of accesses to the device 700 for server A of the server A100 and also obtains access volume information indicating the volume of accesses to the device 800 for server B of the server B200. Then, the mechanism 550 writes both of them in a server access processing time/IO number table 450. In this case, the volume is, for example, an average IO time obtained by dividing the total process running time by the number of reads/writes.

Specifically, if the server A100 or B200 accesses the storage apparatus 300, the function securing mechanism 550 judges which is accessed, the device 700 for server A or device 800 for server B, and obtains a process running time. Then, the mechanism 550 stores the total process running time in the server access processing time/IO number table 450. Simultaneously, the mechanism 550 stores the number of reads/writes in the server access processing time/IO number table 450. Then, this total access processing time is divided by the number of reads/writes and an average IO time is calculated. If the access time is too long, this average IO time is used to reduce a rental fee to be charged to a user.

If this function securing mechanism 550 is provided, for example, even when the performance of a storage apparatus degrades, customer satisfaction can be improved by monitoring the function and reducing the rental fee accordingly. For example, if an average I/O time exceeds one second, the rental fee can be reduced to ⅕.

The charging mechanism 600 calculates a storage service fee to be charged to the server A100 or B200, based on the obtained access volume information.

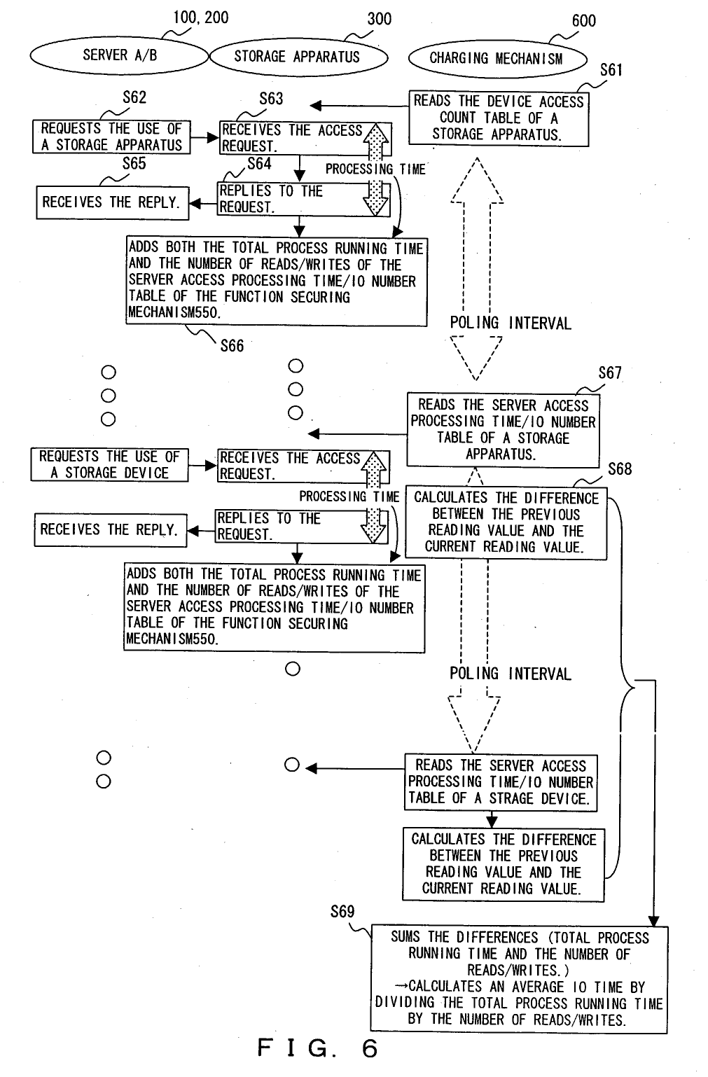

FIG. 6 is a flowchart showing the process of the second preferred embodiment of the storage service of the present invention.

First, in step S61, the charging mechanism 600 reads the device access count table 400 in advance.

Then, in step S62, the server A100 or B200 requests the use of a storage apparatus (device 700 for server 700 or device 800 for server B200) (access to a storage apparatus).

Then, in step S63, the storage apparatus 300 receives the access request. In step S64, the mechanism 600 replies to the access request of the server A100 or B200 that wants to access a storage apparatus.

Then, instep S65, the server A100 or B200 receives Furthermore, in step S66, the storage apparatus 300 updates (adds) both the total process running time and the number of reads/writes of the target server A100 or B200 of the server access processing time/IO number table 450.

After poling for a specific time after the reading in step S61, in step S67, the charging mechanism 600 reads the server access processing time/IO number table 450 again, and in step S68, it calculates the difference between the current reading value and the previous reading value. These processes (reading and the calculation of the difference) are performed at each poling interval.

Then, in step S69, an average IO time is obtained by dividing the differences of the total process running time by the number of reads/writes and use frequency is calculated.

Although the preferred embodiments of the present invention are described so far with reference to the drawings, the storage apparatus of the present invention is not limited to those preferred embodiments as long as the function is realized. The storage apparatus can be a single device, a system composed of a plurality of devices or an integrated device, or a system performing the process through a network, such as a LAN, WAN and the like.

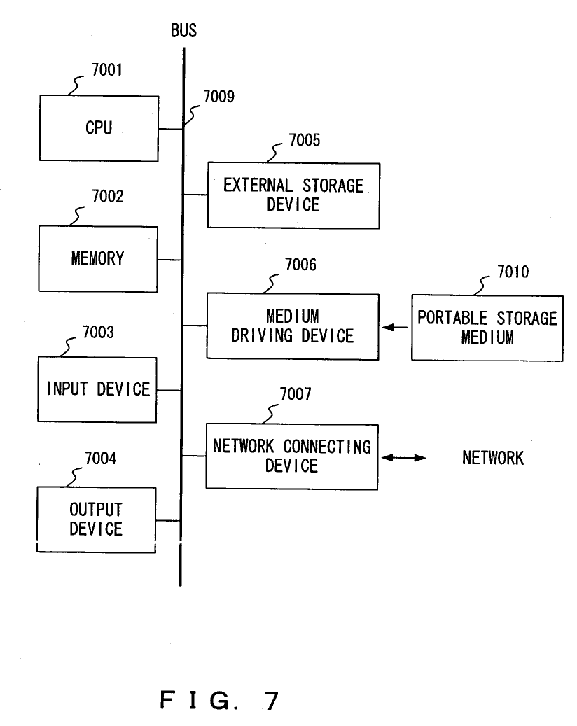

As shown in FIG. 7, the storage apparatus can also be realized by a system comprising a CPU 7001, a memory 7002, such as a ROM and a RAM, an input device 7003, an output device 7004, an external storage device 7005, a medium driving device 7006, a portable storage medium 7010 and a network connecting device 7007, which are all connected to one another by a bus 7009. Specifically, the storage apparatus can be realized if the storage apparatus is provided with a software program code for realizing the preferred embodiment system described above that is recorded on the memory 7002, such as a ROM and a RAM, external storage device 7005 or portable storage medium 7010, and the computer of the storage apparatus reads the program code.

In this case, the program code read from the portable storage medium 7010 or the like realizes the new function of the present invention, and the portable storage medium 7010 or the like on which is recorded the program code, constitutes the present invention.

For the portable storage medium 7010 providing the program code, a flexible disk, a hard disk, an optical disk, a magneto-optical disk, a CD-ROM, a CD-R, a DVD-ROM, a DVD-RAM, a magnetic tape, a non-volatile memory card, a ROM card, a variety of storage media storing data through a network connecting device 7007 (in other words, a communication line), such as electronic mail and personal computer network and the like can be used.

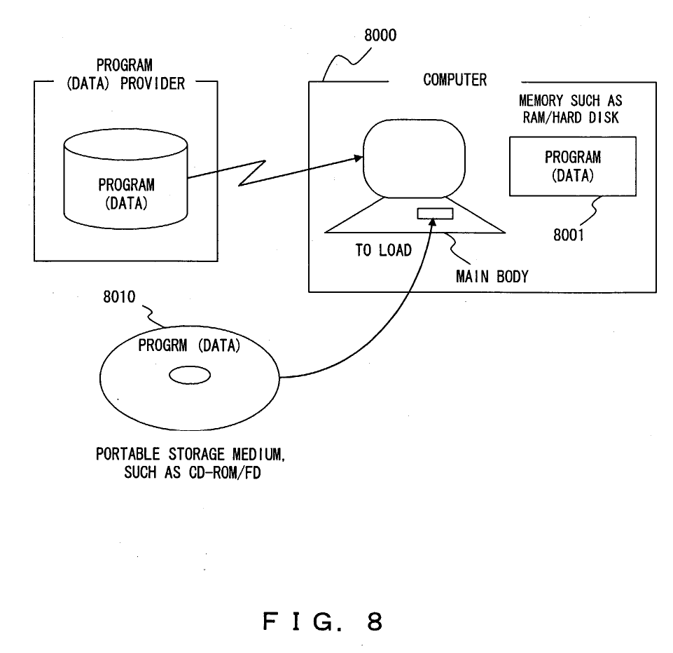

As shown in FIG. 8, if a computer 8000 executes a program code read onto a memory 8001, the function of the preferred embodiment described above can be realized. Alternatively, if an OS operating on the computer 8000 performs a part of the actual process or the entire process according to the instructions of the program code, the function of the preferred embodiment described above can be realized.

Furthermore, if a program code read from a portable storage medium 8010 or a program (data) provided by a program (data) provider is written into the memory 8001 provided for a function extension board inserted in the computer 8000 or a function extension unit connected to the computer 8000, and a CPU provided for the function extension board or unit performs a part of the actual process or the entire process according to the instructions of the program code, the function of the preferred embodiment described above can also be realized.

In other words, the present invention is not limited to the preferred embodiments described above, and it can take a variety of configurations and forms as long as it does not deviate from the subject matter of the present invention.

As described above, according to the present invention, the rental fee of a user that does not use a storage apparatus so much can be reduced. Simultaneously, in storage service business where a storage apparatus is often shared by a plurality of servers, a storage service provider can provide a plurality of clients with a stable function since if the access frequency of a server is low, the load of resources in a storage apparatus is small, and the rental fee of a client can be generally reduced accordingly.

Furthermore, according to the present invention, since a storage apparatus is provided with a mechanism for judging the capacity of use of a storage apparatus, problems occurring in a server when measuring the used capacity of a storage apparatus, that the measurement affects the cpu load of a server and that exclusive software must be installed, can be solved and a problem occurring when measuring the used capacity of a storage apparatus on a connection route between a server and a storage apparatus, that accurate information cannot be secured can be solved, and the used capacity of a storage apparatus can be accurately measured accordingly.

What is claimed is:

1. A storage service method adopted in a storage apparatus managing storage devices that a requester's processing device accesses to store information, comprising:
obtaining access volume information indicating the volume of accesses to the storage apparatus of the requester's processing device; and
calculating a storage service fee to be charged to the requester's processing device, based on the obtained access volume information.

2. The storage service method according to claim 1, wherein the volume is the number of accesses to the storage device.

3. The storage service method according to claim 1, wherein the storage service fee is calculated using a time coefficient that varies depending on when the storage device is accessed and that is relatively larger in the daytime than at night.

4. The storage service method according to claim 2, wherein the storage service fee is calculated using a time coefficient that varies depending on when the storage device is accessed and that is relatively larger in the daytime than at night.

5. The storage service method according to claim 1, wherein a writing ratio, which is a ratio of the number of instances of writing to the number of accesses, is calculated and the storage service fee is calculated using a writing coefficient corresponding the writing ratio.

6. The storage service method according to claim 2, wherein a writing ratio, which is a ratio of the number of instances of writing to the number of accesses, is calculated and the storage service fee is calculated using a writing coefficient corresponding the writing ratio.

7. The storage service method according to claim 1, wherein the volume is a process running time during which the storage device is accessed.

8. The storage service method according to claim 7, wherein the degree is an average IO time obtained by dividing the process running time by the number of reads/writes.

9. A storage service program run in a storage apparatus managing storage devices that a requester's processing device accesses to store information, enabling a computer to execute a process, said process comprising:
obtaining access volume information indicating the volume of accesses to the storage apparatus of the requester's processing device; and
calculating a storage service fee to be charged to the requester's processing device, based on the obtained access volume information.

10. A storage apparatus managing storage devices storing information, comprising:
an access volume information obtaining unit obtaining access volume information indicating the volume of accesses to the storage apparatus of a requester's processing device; and
a storage service fee calculating unit calculating a storage service fee to be charged to the requester's processing unit based on the access volume information obtained by the access volume information obtaining unit.

11. A storage apparatus managing storage devices storing information, comprising:
access volume information obtaining means for obtaining access volume information indicating the volume of accesses to the storage apparatus of a requester's processing device; and
storage service fee calculating means for calculating a storage service fee to be charged to the requester's processing unit based on the access volume information obtained by the access volume information obtaining means.
